(19) United States
(12) Patent Application Publication
(10) Pub. No.: US 2005/0108072 A1
(43) Pub. Date: May 19, 2005

(54) A METHOD AND SYSTEM FOR STOCHASTIC ANALYSIS AND MATHEMATICAL OPTIMIZATION OF ORDER ALLOCATION FOR CONTINUOUS OR SEMI-CONTINUOUS PROCESSES

(76) Inventor: Theodora Retsina, ATLANTA, GA (US)

Correspondence Address: AMERICAN PROCESS INC;STEVE RUTHERFORD, 56 17TH STREET N.E., ATLANTA, GA, 30309, US

(21) Appl. No.: 10/904,468

(22) Filed: Nov. 11, 2004

Related U.S. Application Data
(63) Continuation of application No. 60/520,336, filed on Nov. 17, 2003.

(51) Int. Cl. G06F 17/60

(52) U.S. Cl. 705/7

(57) ABSTRACT

A method and system for optimizing and issuing order allocations to the supply chain network for organizations with multiple continuous or semi-continuous production units; the uncertain parameters of each major component of the supply chain network, and the random nature of customer orders are accounted for through stochastic analysis. The application updates dynamically allowing changeable objective priorities so that users are provided real-time optimized order allocation decisions on the basis of current information.

### FIELD OF THE INVENTION

This invention relates, in general, to the optimization of order allocation for organizations with multiple continuous or semi-continuous production units, and more particularly to the real-time dynamic optimization of changeable objective priorities taking into consideration the uncertain parameters of each major component of the supply chain network, and the random nature of customer orders.

### BACKGROUND OF THE INVENTION

Most organizations in the continuous or semi-continuous process industry do not have order allocation systems that optimize their overall objectives; at best they focus on pre-determined objective priorities that cannot readily be changed and are seldom, if ever, truly optimized. The response to a change in objective priority, e.g., an urgent delivery request making customer satisfaction the top priority, is typically achieved without regard to cost minimization on an organization-wide basis as the tools are not available to dynamically obtain and process all the variables.

Traditional order allocation systems use only a limited amount of current data such as order, inventory, and shipping status, and rely on projections for the some of the most important variables, e.g., production line capability, cost per unit production. Furthermore traditional order allocation systems are not capable of providing an instant response to real time situations, such as the breakdown of a production line, loss of inventory through damage, while still optimizing the current objective priorities.

Accordingly a need exists for a convenient, real-time method of providing easily accessible, dynamically optimized order allocation decisions based on up to date information.

### SUMMARY OF THE INVENTION

The present invention is an automatically updating, on-line software application system that continuously provides real-time, dynamically optimized, order allocations to the various facilities of an organization's supply chain network. The present invention's optimization for organizations in the continuous or semi-continuous process industry can take into consideration the uncertain parameters of the entire order allocation process by treating them as stochastic variables. An integrated process simulation and analysis tool feeds real-time cost duration curves for each individual production unit into the optimization model. Optimized decisions are exportable for electronic distribution to provide easy access by all connected authorized users.

### BRIEF DESCRIPTION OF THE DRAWINGS

A more complete understanding of the present invention may be obtained by reference to the following Detailed Description when read in conjunction with the accompanying Drawings wherein:

FIG. 1 illustrates a typical production unit of a supply chain facility and its attributes

FIG. 2 illustrates the supply chain production facility configuration

FIG. 3 illustrates an overview of the present invention's order allocation information flow

FIG. 4 illustrates typical production line cost duration curves

FIG. 5 illustrates a schematic diagram of the present invention's software application

FIG. 6 illustrates an organization's supply chain network

FIG. 7 illustrates the mathematical model for the production allocation problem

### DETAILED DESCRIPTION OF THE INVENTION

An organization's possible objectives are identified, e.g., on-time order fulfillments, maximize profit, maximize revenue, minimize cost per unit production, domestic to off-shore production ratios, etc.

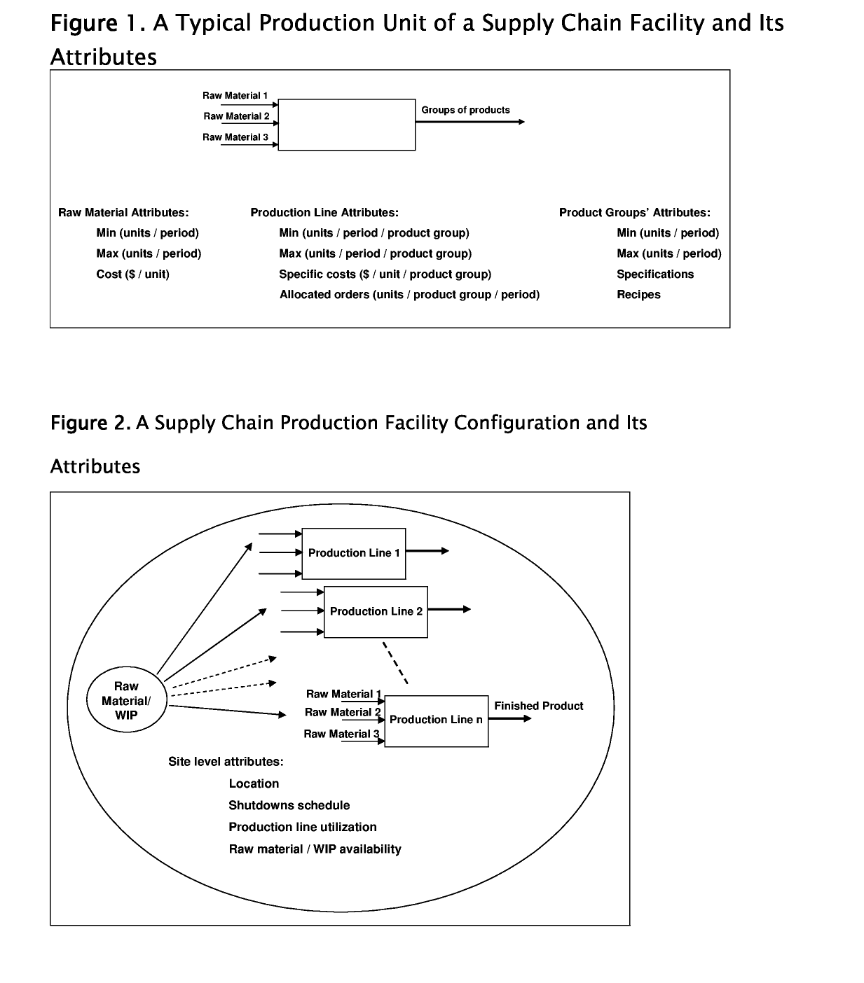

A study is made of the organization-wide supply chain units and their links, clearly defining their boundaries. An analysis is made to determine the relevant parameters that significantly impact the possible objectives, e.g., order quantity/specification/date required/delivery location/backlogs, inventory raw materials/work-in-progress/finished goods/location/costs, production line capacity limits/product grades/shutdowns/location/cost duration curves, shipping routes/durations/availability/costs/transportation costs. A representation of a typical supply chain production unit and production facilities are seen in FIG. 1 and FIG. 2 respectively.

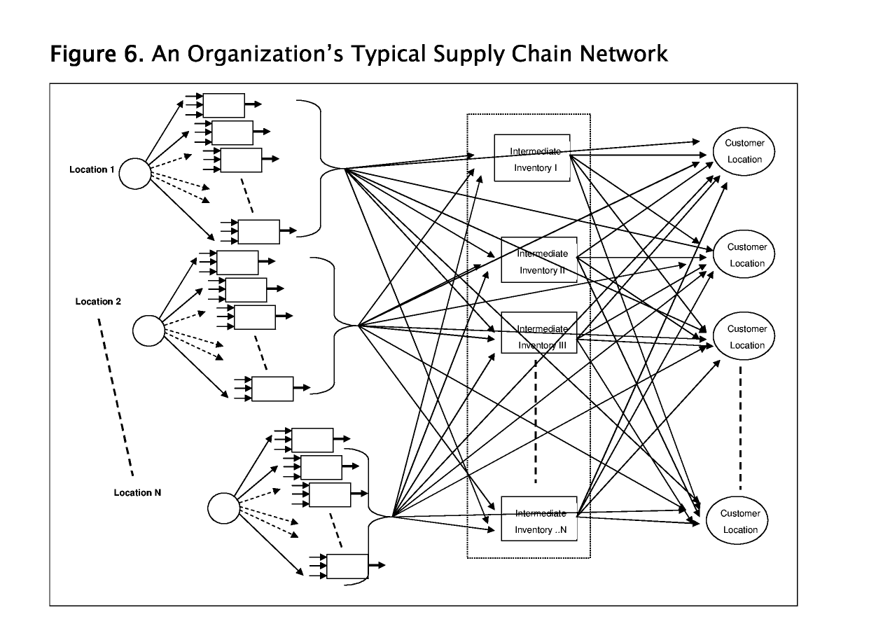

A mathematical model is created in the present invention's software application to simulate the supply chain configuration and interactions, including the relevant parameters. The complexity of the interactions within a typical supply chain network is illustrated in FIG. 6.

Real-time marginal cost duration curves for the various production units of the supply chain are generated by the present invention's specific module which in combination with the invention's supply chain process simulation model performs what-if analyses for production rate values for the various production units and exports the results in tabular and/or graphical form. These marginal cost duration curves can be used to rank all the production units in the organization's supply chain in user selectable terms.

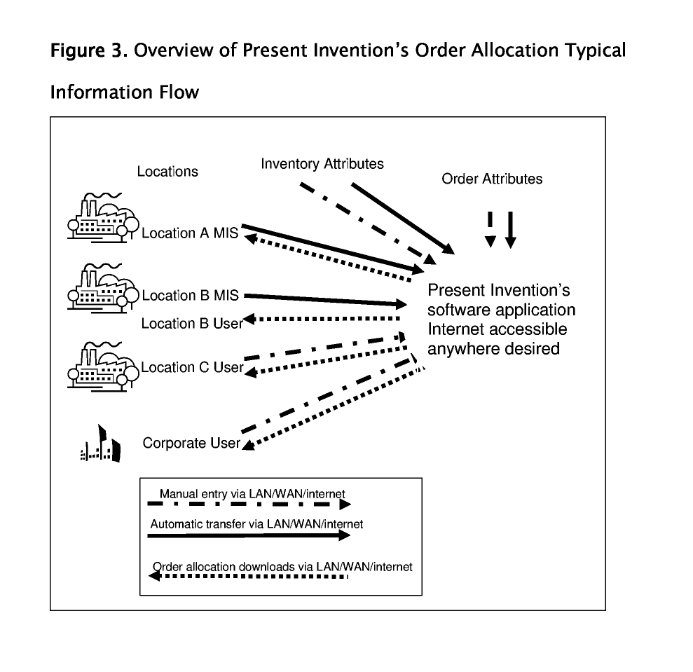

Once the supply chain model is set up, relevant parameter data is electronically uploaded into the present invention as illustrated in FIG. 3. A data encryption module is included whenever secure data transfer is required.

Many organizations have management information systems (MIS) or other data capture systems that electronically store the relevant parameter data at their various locations. Those locations can dynamically upload the relevant parameter data automatically into the invention's model via an interface. Locations without MIS or equivalent capability will enter the relevant parameter data manually.

At pre-set times or on-demand, the present invention will solve for order allocation to optimize the selected objectives using the uploaded relevant parameter data.

The present invention has the ability to use distributional forecasts of the order demands, other uncertain parameters, and all other available information to give a globally optimal and realistic solution. For the stochastic modeling of the uncertain parameters, historical data are transferred from the organization's MIS to the present invention's software application in which they are analyzed statistically by categorizing them to standard probability distributions and calculating their mean value and variance. The statistical analysis is supplemented with a graphical environment depicting various charts, graphs and statistical parameters of the stochastic variables. In this way, the model provided by the present invention is realistic and robust, taking into consideration the various uncertainties occurring in a supply chain, such as the order amounts, the transportation times or the energy costs.

The present invention's software application includes tools that can electronically download order allocations, directly or indirectly to each production unit and/or production facility, into the organization's MIS, or any other location or to any authorized user with world wide web access for action and implementation; these can be in various formats such as tables, graphical charts, and reports.

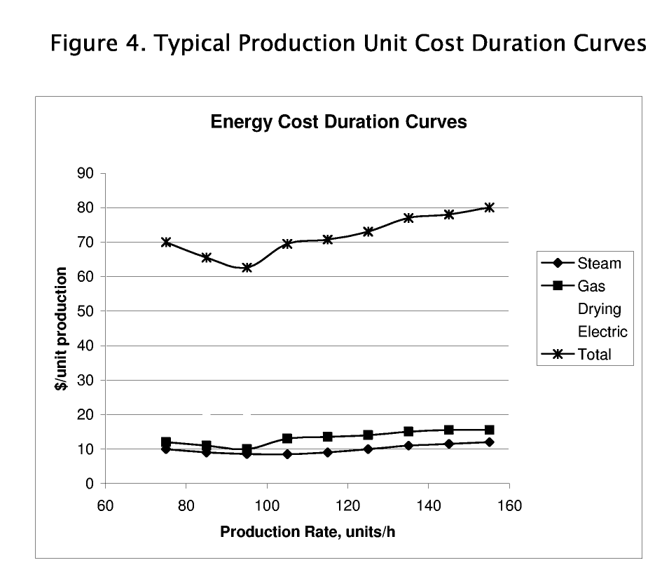

The supply chain relevant parameters are comprised of fixed and variable data. An organization will have much of this in a format that can be used directly. However some data will not be available in the required format and needs intermediate processing; the most significant being production line cost per incremental unit of production that is typically both variable and non-linear; in these instances cost duration curves are created. The production line cost duration curves are derived by statistical analysis of actual production line data and are configured to allow perpetual updates. A typical cost duration curve is illustrated in FIG. 4.

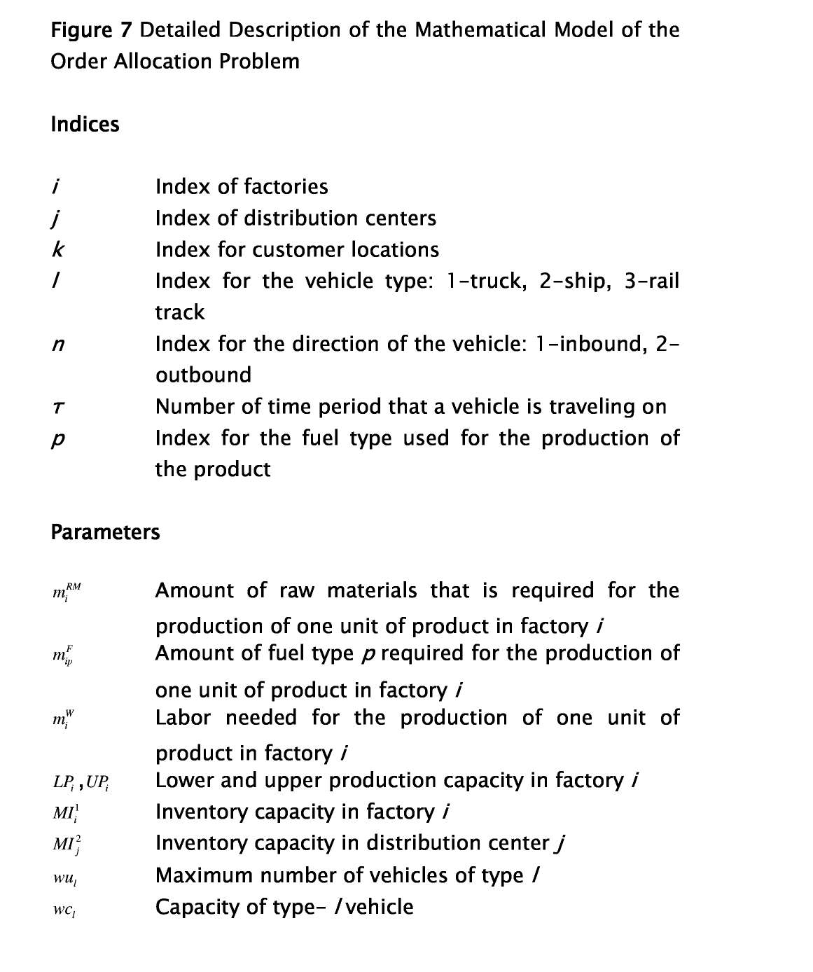

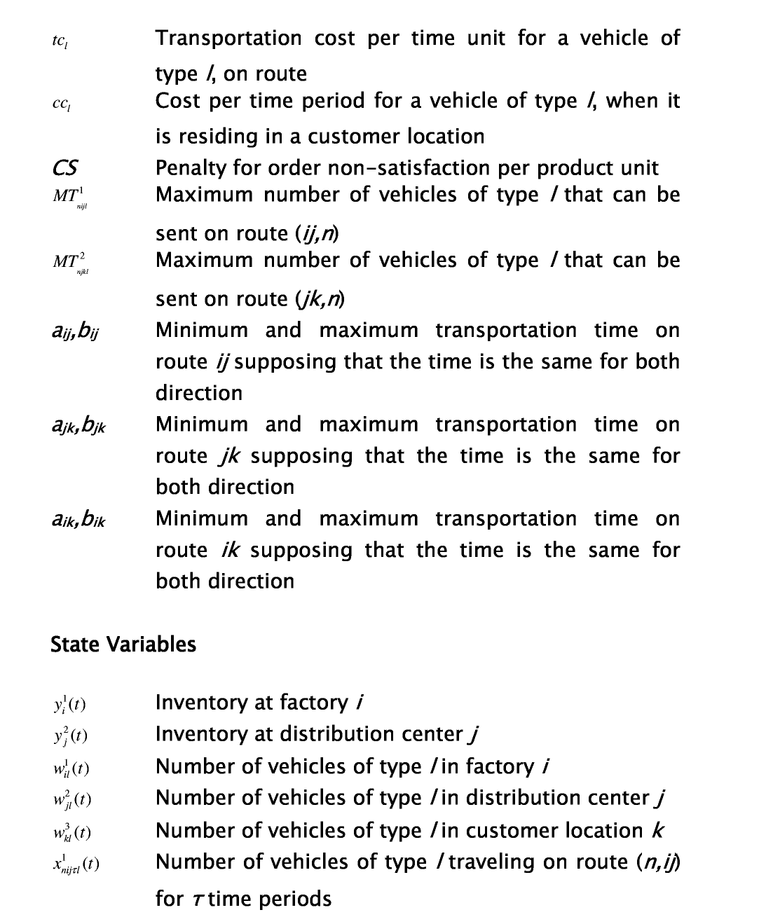

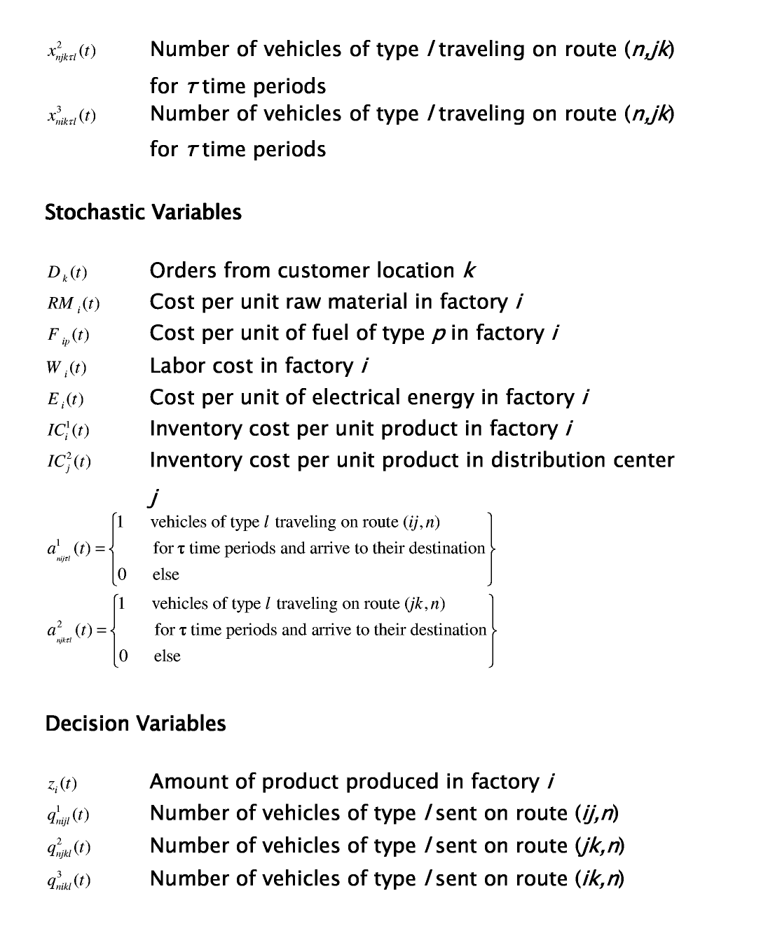

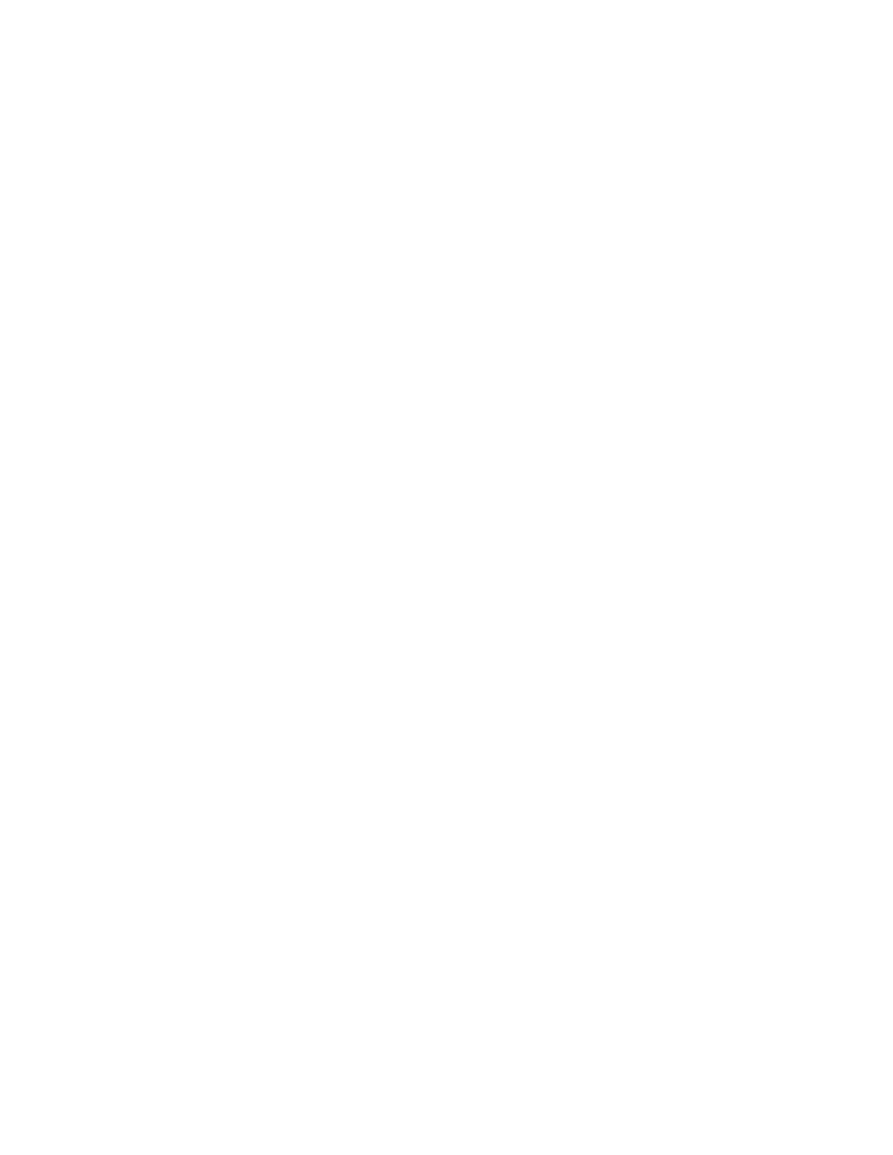

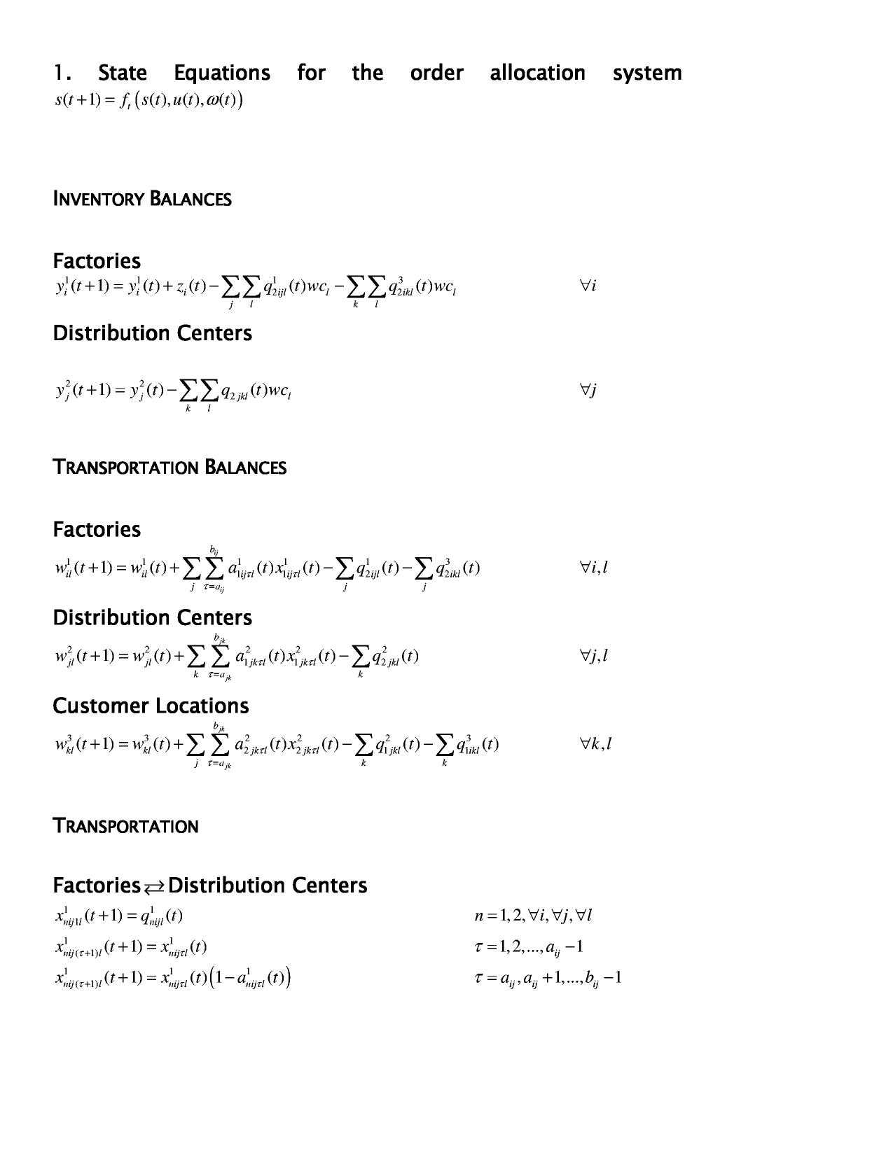

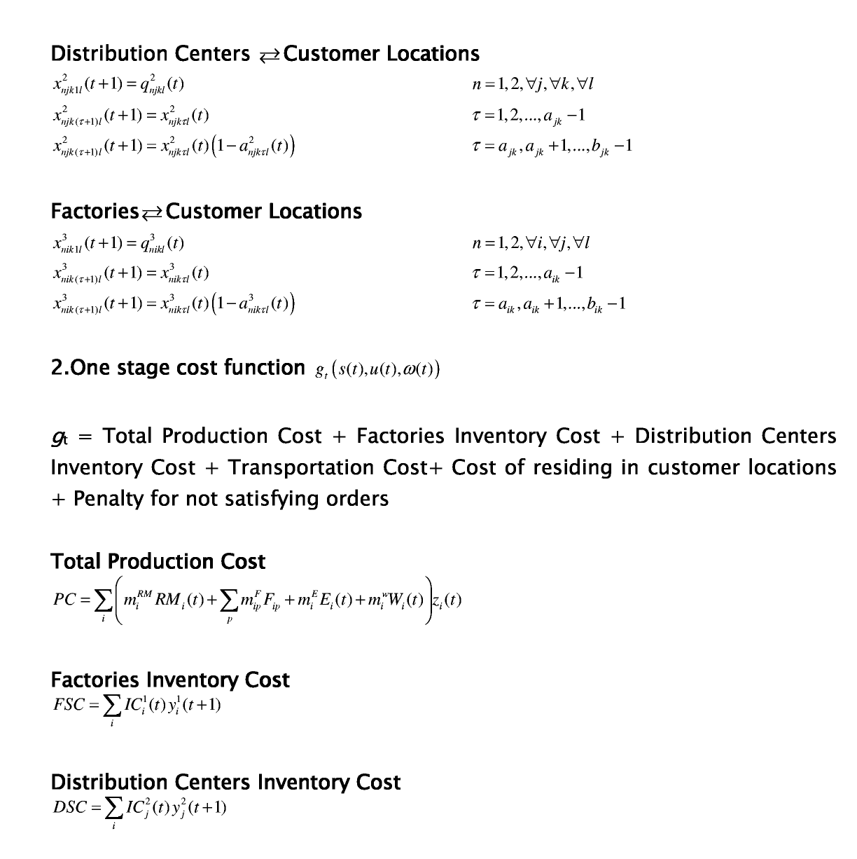

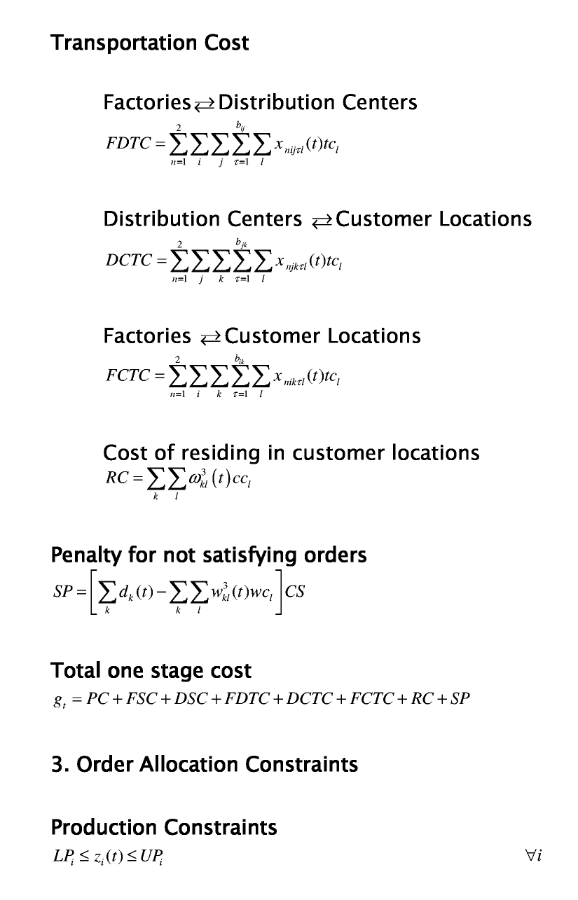

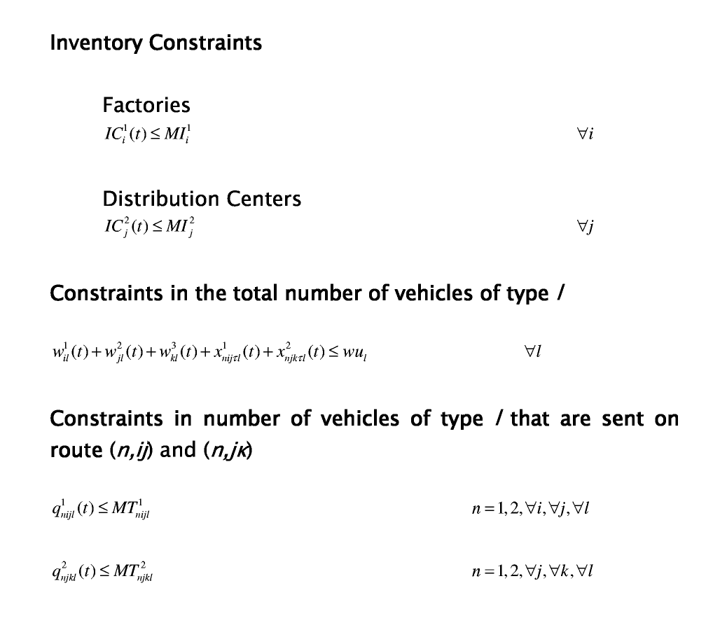

The model consists of several equations for each independent supply chain unit. The supply chain units are linked through other equations that describe the material transfers between the units. The model takes into consideration demand uncertainty, stochastically varying multi-period transportation times, as well uncertainties in the various energy costs. A detailed description of the invention's mathematical model is presented is provided in FIG. 7.

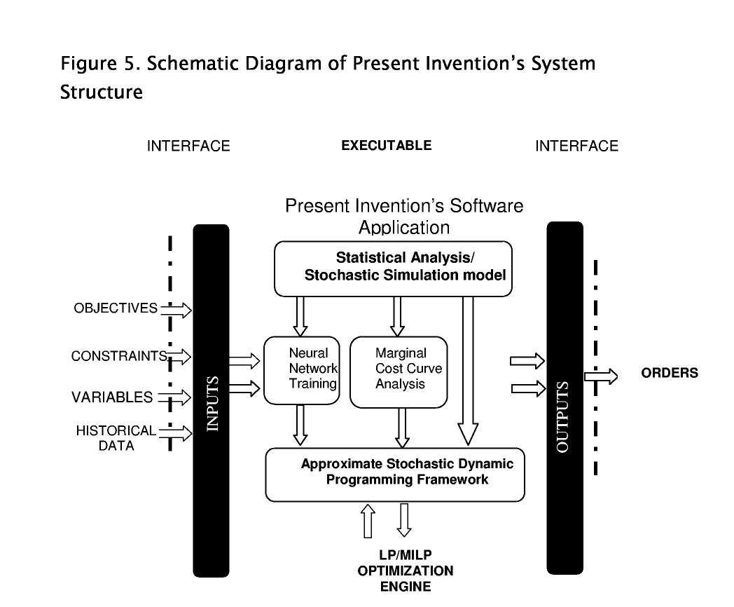

An organization's supply chain constraints, variable relevant parameter data values, and the selection for objectives to be optimized, i.e., the objective functions, are dynamically uploaded into the model. The array of equations is fed into a generic linear programming/mixed linear programming (LP/MILP) engine which solves for order allocations to optimize the objective functions and outputs these to the present invention's software application for automatic downloading to the organization. A schematic representation of this is shown in FIG. 5.

The generic LP/MILP is embedded in a dynamic programming scheme that uses neural networks and is able of taking into consideration in the objective function the impact that present decisions will have on the future behavior and profitability o the supply chain.

Neural networks and other approximation architectures are employed to model the impact of present decisions to the future, known as the cost-to-go function in the dynamic programming field. The approximation architecture is trained with data, downloaded by the invention from the organization's MIS, by using an incremental stochastic gradient training methodology. This training methodology contains a constraint that ensures convexity of the resulting approximation architecture. In this way, the invention creates a convex approximation of the cost-to-go function ensuring the existence of a globally optimal solution of the optimization problem.

The invention has the ability to exploit the structure of the resulting optimization problem and identifying the most efficient formulation. It can identify and formulate the order allocation model as a network flow model. If this is the case, then it can solve the order allocation model by employing specifically tailored network flow algorithms that produce globally optimal solutions in polynomial time.

The approximate stochastic dynamic programming methodology implemented in the present invention allows the decomposition of the multi-period problem of order allocation to smaller, easier sub-problems. This provides the present invention the advantage of producing globally optimal solutions of the order allocation model in real-time.

A gap analysis is included in the present invention. This is a function that makes a real-time comparison between the optimized order allocation decisions against the actual supply chain operation, determines the gap (difference) between these, analyses the lost opportunities in terms of cost, and outputs the cost penalties together with a recommendation for corrective actions to the facility's MIS for a real-time user awareness of the penalty associated with not following the optimized order allocation decisions.

The invention optimization parameters will have many manifestations, including allocation of labor, raw materials, energy, etc. In these manifestations this software application is customized to cover any optimization variable in any production facility.

The present invention's software application may also have parts of logic or expert system programs imbedded in it.

Although other modifications and changes may be suggested by those skilled in the art, it is the intention of the inventors to embody within the patent warranted hereon all changes and modifications as reasonably and properly come within the scope of their contribution to the art.

1. A method for real-time solving the selected objective function by on-line optimization of the order allocation problem for organizations with multiple production units in the continuous and semi-continuous process industry comprising:
utilizing a customizable software application and computerized system to perform the following steps:
configure a mathematical model of the supply chain network of an organization; and
configure a mathematical model of selected major production facilities in terms of their major production units; and
configure a mathematical model of selected major production units; and configure a mathematical model of flows between major production facilities and between selected major production units; and
configure a matrix that dynamically optimizes all the mathematical models to a defined objective function in real-time taking into consideration uncertain parameters of the model; and
enter default attributes for the major production facilities and major production units, such as location, minimum and maximum capacity, preferred operating rates, etc.; and
create a data transfer interface between the invention's software application and the facility's Management Information System (MIS); and
enter current material and utility costs, department operating rates, inventory levels, and temporary process constraints into the invention's software application; and
run a mathematical equation matrix solver software; and
execute a gap analysis of the optimized results to the actual operation; and
store the optimized results from the solver software and the gap analysis results; and
electronically export the optimized results and the gap analysis, to the production facilities, the production units, the organization's MIS, or other designated electronically connected destination and/or print these as hard copy reports.

2. A method according to claim 1, further comprising the steps of:
provision of an infrastructure for the user to model production facilities in the invention software application by selecting major process units from a library of pre-configured modules or by customizing a configurable generic module; and
provision of an infrastructure for the user to model production units in the invention software application by selecting major process equipment from a library of pre-configured modules or by customizing a configurable generic module; and
provision of an infrastructure for the user to model interconnections between the facilities and units in the invention software application by selecting flows from a library of pre-configured modules or by customizing a configurable generic module; and
provision of an infrastructure for the user to model operating practices by completing pre-configured menus.

3. A method according to claim 1, further comprising the step of:
provision of an automatic data entry interface between the facility's MIS and the invention's software application, including a routine that downloads data, runs the model equation solver, runs the gap analysis and automatically uploads the optimized production decisions and gap analysis to the MIS to provide real-time information; and
the automatic routine is initiated both from a scheduler routine with user determined time intervals and from the application's trigger routine that detects when the MIS data values have changed by a user adjustable, discrete or percentage amount.

4. A method according to claim 1, further comprising the steps of:
date-time stamping downloaded MIS data, uploaded optimized production decisions, and storing these in the invention's software application data base; and
provision of logic within the invention's software application to identify out-of-range or infeasible production decisions and flag these to the user through the user's MIS or the invention's graphical user interface.

5. A method according to claim 1, further comprising the steps of:
provision of a customizable graphical user interface to enable the user to make manual entries to the invention's software application, view the cost duration curves of the production units and the distributional forecasts of the uncertain parameters, run the solver and view the optimized production allocations; and
provision for the user to generate and save customized off-line ‘what-if’ scenarios via the graphical user interface.

6. A method according to claim 1, further comprising the steps of:
provision to allow authorized users to access the invention's software application, make changes to configuration/default attributes/temporary constraints, enter data, run the model solver, and/or observe optimized production decisions for the production facility, at any given time from any place where the user has access to the world wide web or to a computer connected to the same local area network to which the invention's software application is connected; and
provision of outputting the optimized production allocation, and other user selectable reports in a video terminal or in a paper form to a location of user's choice.

7. A method according to claim 1 for allowing the optimization overall time period to be automatically sub-divided into smaller increments, further comprising the steps of:
provision to allow users to choose either fixed time intervals or into variable time intervals driven by events; and
provision to allow users to enter fixed time or event time intervals by an automatic period software wizard.

8. A method for the dynamic generation of cost duration curves for the various production units of the supply chain network, further comprising the steps of:
creation of production unit process simulation models continuously updated with real-time production rate data, ambient conditions, marginal fuels, etc., and exporting to the cost duration curve generator; and
incorporation of a self-learning model that continuously monitors the efficiencies of production units and automatically adjusts simulation model and/or cost duration curve generator whenever these change by a pre-determined, user selectable amount.

9. A method to configure a stochastic analysis of the uncertain parameters of the supply chain using historical data, further comprising the steps of:
statistical analysis of the historical data, including calculation of their mean and variance and identification of their probability distribution
incorporation of the uncertain parameters in the optimization framework as stochastic variables.
